(19) United States
(12) Patent Application Publication
(10) Pub. No.: US 2025/0251242 A1
(43) Pub. Date: Aug. 7, 2025

(54) SYSTEM FOR AIRCRAFT NAVIGATION BASED ON IMAGE PROCESSING

(71) Applicant: Visto 360 Al, Inc, Ann Arbor, MI (US)

(72) Inventors: Ryan Michael Farris, Fairfax, VA (US); Clyde Michael Stanfield, Brighton, MI (US)

(21) Appl. No.: 19/048,038

(22) Filed: Feb. 7, 2025

Related U.S. Application Data
(60) Provisional application No. 63/550,675, filed on Feb. 7, 2024.

(51) Int. Cl. G01C 21/00; G06T 7/73; G08G 5/57

(52) U.S. Cl. CPC G01C 21/005; G06T 7/73; G06T 2207/10028; G06T 2207/20081; G06T 2207/20084; G08G 5/57

(57) ABSTRACT

Technology is disclosed herein for a system for aircraft navigation based on LiDAR image processing. In an implementation, a computing system onboard an aircraft receives first and second imaging data of an area of terrain from first and second imaging sensors onboard the aircraft. The computing system identifies, by a first neural network, a first location of the aircraft based on a location of a landmark identified in the first imaging data. The computing system also identifies, by a second neural network, a second location of the aircraft based on the location of the landmark identified in the other imaging data. The computing system determines a composite location of the aircraft based on the first and second locations.

### CROSS REFERENCE TO RELATED APPLICATIONS

This application is related to and claims the benefit of priority to U.S. Provisional patent application entitled “SYSTEM FOR AIRCRAFT NAVIGATION BASED ON LIDAR IMAGE PROCESSING,” Application No. 63/550,675, filed 7 Feb. 2024, the contents of which is incorporated by reference in its entirety for all purposes.

### TECHNICAL FIELD

Aspects of the disclosure are related to the field of aircraft navigation and to image processing including object detection and classification.

### BACKGROUND

The use of unmanned aerial vehicles (UAVs) for commercial or military operations, such as reconnaissance or delivery, is rapidly increasing due to significant improvements in the range and power of such vehicles. For example, UAVs can also be programmed to fly a flight plan autonomously which allows for a much greater range of operations, such as allowing UAVs to be sent to hard-to-reach locations. For military use, UAVs can be deployed for operations in contested areas without exposing military personnel to danger. In addition, the relatively low cost of UAVs makes them highly cost effective where there may be a high rate of loss.

As advances in technology enable a greater reliance on unmanned aerial vehicles for military applications, so too, will countermeasures taken by opponents to thwart these devices in contested areas or hostile environments. For example, in a GPS-denied environment, UAVs may lack the ability to autonomously follow a flight plan for a long-range mission. To the extent that a UAV can be piloted by a remote operator, for example, using a first-person camera view transmitted by the UAV, the range of such vehicles is constrained by the ability to maintain communication with the remote operator. Moreover, such communication can be used by an opponent to track the location of the remote operator. And in environments of low visibility, the remote pilot may not receive enough visual information from the video transmission to accurately pilot the vehicle for operations demanding extreme precision.

### Overview

Technology is disclosed herein for a system for aircraft navigation based on LiDAR image processing. In an example, program instructions executed by processing circuitry on a computing system direct the computing system to receive first imaging data of an area of terrain from a first sensor onboard an aircraft. The computing system receives second imaging data of the area of terrain from a second imaging sensor onboard the aircraft. The computing system determines, by a first neural network, a first landmark location based on an identification of the first landmark in the first imaging data. The computing system determines, by a second neural network, a second landmark location based on an identification of a second landmark in the second imaging data. The computing system determines a location of the aircraft in three-dimensional (3D) space based on the first landmark location and second landmark location.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for aircraft navigation based on image processing and object detection in an implementation.

FIG. 2 illustrates a process of aircraft navigation based on imaging processing and object detection in an implementation.

FIG. 3 illustrates an operational architecture for LiDAR image processing for aircraft navigation in an implementation.

FIG. 4 illustrates an operational architecture for aircraft navigation based on image processing of various modalities in an implementation.

FIG. 5 illustrates an operational architecture for aircraft navigation based on LiDAR image processing in an implementation.

FIG. 6 illustrates a workflow for aircraft navigation based on LiDAR image processing in an implementation.

FIG. 7 illustrates a computing system suitable for implementing the various operational environments, architectures, processes, scenarios, and sequences discussed below with respect to the other Figures.

### DETAILED DESCRIPTION

Various implementations are disclosed herein for an artificially intelligent (AI) computer vision system for navigating an aircraft, such as an unmanned aerial vehicle, based on processing image data of an area in the vicinity of the aircraft, including object detection and classification of the image data. By capturing image data of different imaging modalities (e.g., electro-optical (EO), infrared, LiDAR), the navigation of the aircraft is made robust to the variety of conditions to which the aircraft may be subject. For example, while EO images may be sufficient for landmark identification while flying in clear weather during the day, during nighttime, thermal imaging sensors may produce more useful imaging data than the EO sensors. Similarly, where Light Detection and Ranging (LiDAR) sensing may be degraded in rainy conditions, a longer wavelength imaging modality such as radar may produce more useful imaging data than LiDAR sensors. By processing image data of multiple modalities of terrain over which an aircraft is flying to ascertain the aircraft's location and direction of travel, the aircraft can continually receive reliable location data for navigation. Thus, aircraft can fly missions using autonomous navigation in low-visibility environments or in areas where Global Positioning System (GPS) signals are unavailable for navigation.

In various implementations, LiDAR image processing for navigation is augmented by imaging in other electromagnetic spectrums or modalities (e.g., electro-optical imaging, radar, etc.) to determine the location of the aircraft under varying conditions. For example, while the aircraft is in flight, an onboard LiDAR sensor captures an image of the terrain, and the aircraft navigation system processes the image to detect identifiable landmarks using a trained convolutional neural network (CNN). When the CNN identifies a landmark in the image, it outputs a location (e.g., latitude and longitude) of the landmark along with a confidence metric indicating a level of confidence in the identification of the landmark. The navigation system can then determine the aircraft's location based on the landmark location. Altitude information can also be determined from ranging information in the LiDAR images so that an accurate location of the aircraft in three-dimensional space can be ascertained.

In various implementations, in addition to the LiDAR imaging, an electro-optical (EO) or other geospatial sensor (e.g., radar, infrared, multispectral) onboard the aircraft captures an image of the same terrain and processes the image to detect identifiable landmarks using a second CNN trained for landmark identification. The second CNN outputs a location based on the landmark identification in accordance with its training along with a confidence metric for the landmark identification. The navigation system on the aircraft receives the position information from the second CNN and, together with the location information based on the LiDAR imaging, computes aggregated position information for the landmark. More specifically, the aggregated position data is based on combining the position information from each CNN weighted according to the respective confidence metrics. Based on the aggregated position information, the navigation system can extrapolate a position of the aircraft, taking into account or correcting for aircraft velocity, angular distortions based on the orientation of the sensors with respect to the terrain or with respect to the location of the landmark within the captured image, or other artifacts or effects which may impact the accuracy in pinpointing the aircraft's location based on the images. Ultimately, the navigation system onboard the aircraft can navigate the aircraft based on the identified present location of the aircraft.

Because the aircraft can pinpoint its location without reference to a GPS signal or communication with a ground station, the aircraft can navigate autonomously in GPS-denied environments and without the risk of exposing the location of a ground station in communication with the aircraft to enemy combatants in a conflicted area. Moreover, using two or more types of imaging produces a robust location identification system. To wit, while LiDAR may be weaker at detecting landmarks in images based on contrast or color, electro-optical imaging will be stronger. And while electro-optical imaging may be weaker at detecting changes in elevation or detecting landmarks in low-visibility conditions, LiDAR imaging will be stronger. Similarly, while the LiDAR images provide ranging information which can be used to determine the aircraft's altitude, LiDAR images are generally going to be coarser in terms of resolution than electro-optical imaging. The finer resolution of the electro-optical imaging may allow for more accurately pinpointing of the landmark location than the LiDAR imaging. In sum, combining the outputs of the CNNs according to the respective confidence metrics takes advantage of the complementary capabilities of the multiple imaging modalities. In addition, beyond the robust capability of the augmented LiDAR navigation system, the use of multiple imaging modalities offers a measure of redundancy in the event that one of the imaging modalities fails.

For the LiDAR-trained CNN to detect landmarks, the neural network is broadly trained on general LiDAR image data to provide a basic level of understanding of topographical and infrastructure features or landmarks which may be captured by aerial imaging. The LiDAR-trained CNN learns to output location data associated with a LiDAR image based on identifying a landmark with a known location in the image. In various implementations, the model also outputs a confidence metric which indicates the model's level of confidence (e.g., as a percentage) in the location identification. Prior to using the model for inference for aircraft navigation, the LiDAR-trained CNN is fine-tuned for a particular area or mission by ingesting training data for the terrain over which the aircraft is expected to fly. Based on the fine-tuning, the LiDAR-trained CNN will then be able to identify landmarks along the aircraft's flight path. During the mission, as the aircraft captures LiDAR images of the ground, the LiDAR-trained CNN outputs the latitude and longitude of the landmarks it detects in the LiDAR images by which the aircraft's present location can be determined.

In an implementation, to process the LiDAR imaging data for navigation, the navigation system of the unmanned aerial vehicle or other aircraft pre-processes the data before ingestion by the LiDAR-trained CNN. For a given LiDAR image of terrain, the three-dimensional (3D) point cloud image of the terrain taken from the aerial perspective is ortho-rectified and projected in a normal orientation to the ground plane to create a two-dimensional (2D) or planar point cloud image. The 2D point cloud image retains altitude information at the cloud points in the form of the point brightness. The 2D point cloud image is ingested by the LiDAR-trained CNN to detect landmarks in the image. When a landmark is identified, the model outputs latitude and longitude information of the landmark. The location data can then be used to extrapolate the latitude and longitude of the aircraft when the LiDAR image was taken. In addition to obtaining the latitude and longitude from the aircraft's LiDAR images, the altitude of the aircraft may be determined based on ranging information in the images, such as the brightness of the points corresponding to the identified landmarks.

To train a second CNN for EO image processing, EO images are fed into the second CNN to learn object detection, such as landmark detection. The EO-trained CNN ingests the training images including landmarks and landmark location coordinate data. The EO-trained CNN is trained to identify the landmarks and return landmark location data and a confidence metric indicating a level of confidence in the identification.

In an implementation, the LiDAR CNN and the EO CNN are broadly trained to provide a basic level of understanding of topography and infrastructure features or landmarks which may be captured by aerial imaging. Landmarks which the CNNs are trained to identify can include unique features of the terrain such as manmade structures (e.g., buildings, dams, bridges, roadways, etc.) or natural formations (e.g., bodies of water, ridgelines, etc.). Training datasets for the CNNs are generated based on available LiDAR image data with corresponding electro-optical image data. For example, the LiDAR CNN and EO CNN may be trained on Southeastern Michigan Council of Governments (SEMCOG) Open Data which includes LiDAR imaging data of lower Michigan along with map or imaging data of the same region. In some training or fine-tuning scenarios, if actual LiDAR imaging data is unavailable, synthetic LiDAR data or synthetic EO image data may be created from maps, 3D spatial images, and/or other types of imaging of the region of interest. For example, images may be created or modified to include distractions or occlusions to make the neural networks more robust during inference. The EO images for training or fine-tuning may be sourced from imagery captured by satellite or aircraft imaging devices. The EO images may be images in the visible wavelengths or other wavelengths, such as infrared; other modalities may be trained to augment the LiDAR image processing such as radar.

In various implementations, the LiDAR image data and EO image data are resampled into tiles of a sampling space (i.e., geographic area) commensurate with the image or view size and/or scale captured by the onboard sensors. The image tiles for the LiDAR and the EO training include landmarks and landmark location coordinates (e.g., latitude and longitude). The image tiles taken from the LiDAR image data and EO image data are selected for use in training which vary in the types of landmarks which the onboard sensors may encounter. During training and for inference, the models generate a confidence metric reflecting the models' ability to identify a landmark. For example, for an image tile with a highly identifiable landmark (e.g., the Pentagon building), the model may return location information with a high confidence score, while for an image tile with no identifiable landmarks (e.g., farmland), the model may return a location with a low confidence score.

As the aircraft navigates based on the latitude and longitude of the composite or aggregated position data from the LiDAR CNN and EO CNN, an independent position confirmation or verification system executing onboard the aircraft may operate to check the position data derived from the LiDAR and other image data against previously determined locations and against location information obtained from navigation devices or sensors onboard the aircraft, such as gyroscopic, compass, accelerometer, inertial measurement unit (IMU), and/or altimeter data. For example, if the LiDAR CNN identifies the Eiffel Tower in Las Vegas as the Eiffel Tower in Paris, the independent verification system may detect significant difference between the aircraft's presently identified location and previously identified location, the verification system will flag the data as false. Alternatively, if the aggregated position information does not correlate to the location information of the sensor data (i.e., if the difference exceeds a threshold value), the confirmation system will filter out the data. The independent location verification can also be used to fine-tune the results of the LiDAR image processing to improve accuracy.

In some implementations, the onboard LiDAR sensors may obtain images of the terrain from sideview or outward-looking perspective in addition to or as an alternative to a downward-looking perspective. The outward-looking perspective may capture identifiable profiles of landmarks, such as mountain ranges. 3D point cloud data of the outward-looking perspective may be processed by the navigation CNN in a similar manner, but with the navigation CNN trained to identify landmarks or landmark profiles for outward perspectives. Position data for the landmarks may be determined according to the compass direction of the LiDAR sensor when capturing the images.

Technical advantages of the technology disclosed herein enable aircraft, such as unmanned aerial vehicles, to fly missions autonomously in zero-visibility, GPS-denied environments using low-cost and readily available LiDAR technology. Coupled with sensors of other modalities, such as EO or infrared, the navigation system is made robust to scenarios where LiDAR data may be degraded. For example, when flying in areas of precipitation, the navigation system receives more reliable (higher fidelity) imaging data from other (non-LiDAR) sensors. Thus, augmenting the LiDAR imaging with another imaging modality improves the reliability of the system across different environmental conditions while also providing a measure of redundancy.

In a GPS-denied environment, the technology disclosed herein allows an aircraft to determine its position (e.g., latitude and longitude) based on LiDAR or other imaging data and navigate to its target based on dead-reckoning, that is, by determining which direction and distance to fly to intercept the target based on its present position. As the aircraft receives updated position information, it continually recomputes its flight path to the target until it reaches the target. Because LiDAR sensors can obtain high-quality imaging data in a variety of conditions, including total darkness, the LiDAR navigation system enables an aircraft to fly in GPS-denied conditions regardless of visibility. Moreover, the neural network technology for detecting landmarks in LiDAR and other imaging modalities can be rapidly fine-tuned for a particular mission, so the technology is readily adaptable to environments where terrain conditions may have undergone a recent change, for example, due to devastation from extreme weather conditions or military operations.

Other technical advantages include rapid, low-cost deployment of the technology using commercial, off-the-shelf hardware. Indeed, the computing hardware to support real-time AI LiDAR image processing is not only inexpensive, but much like a smartphone, is also lightweight, requires little power, and is readily available.

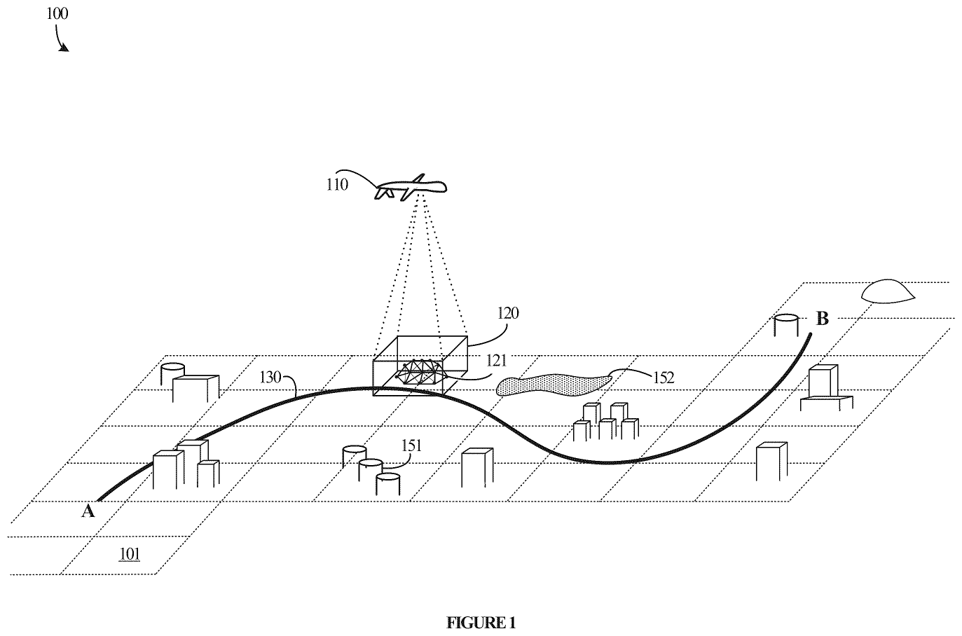

Turning now to the Figures, FIG. 1 illustrates operational environment 100 for aircraft navigation based on LiDAR image processing in an implementation. Operational environment 100 includes aircraft 110 capturing 3D point cloud 120 of the terrain below using an onboard LiDAR imaging sensor (not shown). Aircraft 110 navigates by means of LiDAR navigation system to fly flight path 130 from launch point A to destination B. Operational environment 100 also includes tiles 101 representative of images or sampling spaces of the terrain overflown by aircraft 110 as it flies flight path 130. Tiles 101 may include various topographical features such as man-made structures 151 and natural formations 152.

Aircraft 110 is representative of a vehicle, such as an unmanned aerial vehicle, which is capable of flying flight path 130 from launch point A to destination B and which is capable of navigating according to LiDAR imaging obtained from an onboard LiDAR sensor. In an implementation, aircraft 110 is an unmanned aerial vehicle including a flight control system which transmits flight control commands to an electromechanical system. The electromechanical system operates propulsion engines and flight control surfaces onboard aircraft 110. Aircraft 110 also includes a number of sensors which detect the motion of aircraft 110, such as IMUs, accelerometers, and altimeters, and its environment, such as barometers, GPS sensors, imaging equipment including LiDAR sensors, and so on. Although depicted in FIG. 1 as a fixed-wing aircraft, it may be appreciated that aircraft 110 also includes rotary wing aircraft (e.g., quadcopter).

As aircraft 110 flies flight path 130, the onboard LiDAR sensor continually captures LiDAR images including 3D point clouds, of which 3D point cloud 120 is representative. To navigate from launch point A to destination B (if, for example, the ability to navigate via GPS is unavailable), aircraft 110 tracks its location according to landmarks along flight path 130. The landmarks are identified by the navigation system onboard aircraft 110 which provides an indication of the present location of aircraft 110. Based on identifying its present location, the flight control system of aircraft 110 can continually plot and update flight path 130 to reach destination B.

3D point cloud 120 is representative of an image of an area of a tile of tiles 101 captured by a LiDAR sensor onboard aircraft 110. 3D point cloud 120 is captured by scanning the area with one or more lasers and determining the elevations of the terrain at various locations in the area. This information is used to generate a 3D map or representation of the topography of the area which indicates changes in elevation by mapping the points according to their location and elevation. As illustrated, 3D point cloud 120 indicates elevations associated with landmark 121.

Tiles 101 are representative of sections of an area of interest which have been imaged by LiDAR and EO sensors to identify landmarks for navigation. Tiles 101 are generated from the LiDAR and EO images of the terrain near or along flight path 130. Tiles 101 can include high-value or highly identifiable landmarks of known locations which the navigation system can identify in LiDAR imagery. The LiDAR and EO images of tiles 101 are fed into convolutional neural networks trained for each imaging modality to identify landmarks in images along with the locations (e.g., latitude and longitude) of the landmarks. The trained CNNs may be fine-tuned with training data for a specific area, mission, or flight path. For example, as illustrated, the neural networks of the navigation system onboard aircraft 110 may be fine-tuned according to training data which includes imaging of the terrain between launch point A and destination B. In some implementations, tiles 101 may be configured to overlap to improve the likelihood of capturing landmarks at the edges of the tiles.

In a brief operational scenario involving elements of operational environment 100, as aircraft 110 flies from launch point A to destination B, an onboard LiDAR sensor captures 3D point clouds of sections of the terrain. As illustrated in 3D point cloud 120, sections of topography are mapped by the LiDAR sensor to points in three-dimensional space according to shapes detected in the terrain. As the LiDAR images are captured, the navigation system onboard aircraft 110 projects the 3D point clouds into 2D point clouds of the terrain and processes the 2D point clouds using a CNN trained to identify landmarks from 2D point clouds, such as landmark 121. Having identified a landmark in a point cloud, the navigation system can identify the latitude and longitude of the landmark. The CNN also outputs a level of confidence for the location information determined from the LiDAR image.

Operating in parallel with the LiDAR CNN, an EO sensor onboard aircraft 110 captures EO images of the terrain. As the EO images are captured, the navigation system processes the images using a second CNN trained to identify landmarks from EO images. Having identified one or more landmarks in an image, the navigation system can identify the location information (latitude and longitude) of each landmark. The second, EO-trained CNN also outputs a level of confidence in the location information determined from the EO image.

Based on location information from the LiDAR imaging and the EO imaging, the flight control system onboard aircraft 110 computes a location of aircraft 110 by weighting the location information of the two modalities according to the respective confidence levels. For example, the flight control system may extrapolate a location of the aircraft from the landmark location information of each landmark identified in the LiDAR imaging and EO imaging and generating a composite location by aggregating (e.g., averaging) the extrapolated locations weighted according to the respective confidence metrics. For example, if the LiDAR-trained CNN identifies three landmarks and returns location information for each of the three landmarks and if the EO-trained CNN identifies two landmarks and returns location information for each of the two landmarks, the composite location of the aircraft is determined based on five extrapolated locations according to their respective confidence metrics. In some scenarios, the flight control system may first extrapolate a location of the aircraft for each imaging modality based on location information of each landmark identified by that modality, then generate a composite location by aggregating (e.g., averaging) the extrapolated locations of the modalities according to their respective confidence metrics. With the aircraft location determined according to LiDAR and EO imaging, the flight control system onboard aircraft 110 continually recomputes its trajectory to reach destination B.

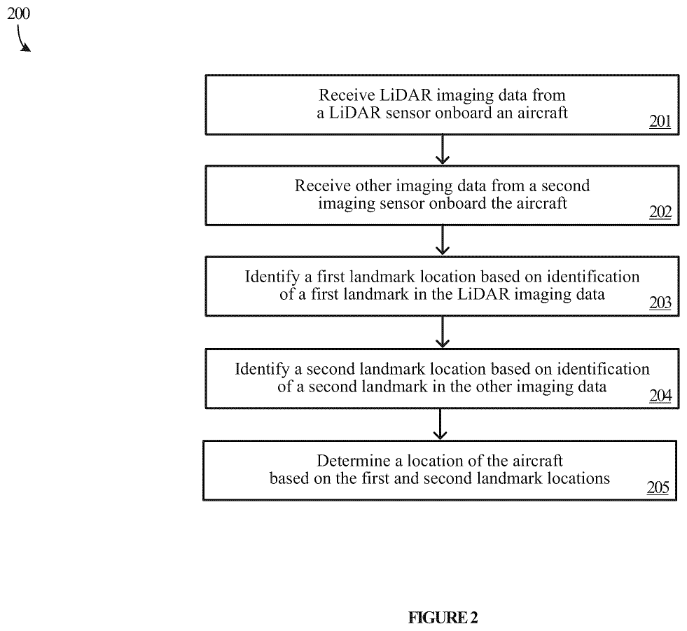

FIG. 2 illustrates a method of aircraft navigation based on LiDAR image processing in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device, such as a flight or avionics computer onboard an aircraft, receives LiDAR imaging data from a LiDAR sensor onboard an aircraft (step 201). In an implementation, one or more LiDAR sensors onboard the aircraft capture LiDAR images of the terrain below the aircraft. The LiDAR images include 3D point clouds including elevation information according to location. The computing device also receives other imaging data from another onboard imaging sensor (step 202). In an implementation, a second imaging modality captures images from an onboard sensor, such as an EO, infrared, radar, or multispectral sensor. For example, one or more EO imaging sensors onboard the aircraft may capture EO images of the terrain below the aircraft.

The computing device identifies a location of a first landmark in the LiDAR imaging data (step 203). In an implementation, the computing device orthorectifies the 3D point cloud data and projects the orthorectified data to a ground plane to create 2D point cloud data. A CNN ingests the 2D point cloud data and processes the 2D point cloud data based on its training to identify landmarks in the data. When a landmark is identified in the 2D point cloud data, in accordance with its training, the CNN returns a location (e.g., latitude and longitude) associated with the landmark and a confidence metric which quantifies a level of confidence in the detection or identification of the landmark. The landmark location may be determined by the CNN based on latitude and longitude information of the 2D or 3D point cloud images. The computing device also returns altitude information based on ranging information from the LiDAR imaging data. In some scenarios, the computing device identifies multiple landmarks in the LiDAR imaging data, and the CNN returns locations associated with each of the multiple landmarks.

The computing device identifies a location of a second landmark identified in the other imaging data (step 204). In an implementation, a second CNN trained for EO image processing receives imaging data from an EO imaging sensor and processes the data based on its training to identify landmarks in the data. When a landmark is identified, the second CNN returns a location associated with the landmark and a confidence metric which quantifies a level of confidence in the detection or identification of the landmark. The landmark location may be determined based on the latitude and longitude of the landmark or of the image containing the landmark. In some scenarios, the computing device may identify multiple landmarks in the imaging data, and the second CNN returns locations associated with each of the multiple landmarks.

In various implementations, the CNNs for determining landmark location based on LiDAR and other imaging data, such EO images, are trained based on training data including 2D point cloud data and corresponding EO imaging data which include known or highly identifiable landmarks. The CNNs are trained to detect the highly identifiable landmarks in the data along with position information (e.g., latitude and longitude) associated with the landmarks. During training, as the CNNs process the data to identify landmarks, the output is compared to the ground-truth values (i.e., locations of the known landmark). Subsequent to generalized training, the CNNs may be fine-tuned for a particular geographic area, such as the area to be transited by the aircraft during a mission.

In an implementation, the pairs of images used to train the CNNs include a LiDAR image and an EO image of an area of interest from which location data (e.g., latitude and longitude) can be interpolated for points or locations in the images. In creating training datasets for a generalized training or fine-tuning of the CNNs, the 3D point cloud data, the 2D point cloud data, and/or the corresponding EO imaging data may be resampled so that the data is configured to correspond to a size and/or scale corresponding to the images captured by the respective sensors. For example, the image data of the area of interest that is used for training the CNNs may be subdivided into tiles (e.g., 20 meters by 20 meters, 200 pixels by 200 pixels, etc.) which match the imaging captured by onboard sensors.

The computing device determines a location of the aircraft based on the landmark locations identified in the LiDAR imaging data and other imaging data (step 205). In an implementation, the computing device receives the location information from the CNNs in the form of latitude and longitude. The latitude and longitude of a final or composite location of the aircraft are computed as weighted averages of the latitudes and longitudes of the landmark locations. The weighting for computing the weighted averages is based on the confidence metrics determined by the respective CNNs. The altitude of the aircraft may be determined based on ranging information in the 3D point cloud data. Based on the computed latitude, longitude, and altitude, the computing device determines a flight path to reach the destination. In some implementations, the computing device feeds the composite location as it is determined to a navigation computer or flight control system onboard the aircraft.

In various implementations, the computing device continually acquires imaging data and processes the data to get up-to-date location information. As its present position is determined, the computing device may execute a location verification system to check or confirm the location ascertained based on the output of the CNNs. For example, the verification system may continually calculate latitude and longitude using gyroscopic, compass, IMU, and/or accelerometer data to remove false position determinations from the convolutional neural network. The aircraft location determined based on the physical sensor data may also be used to refine the output of the CNNs to improve accuracy.

Returning to FIG. 1, operational environment 100 illustrates an operational scenario based on process 200 as employed by elements of operational environment 100 in an implementation. In operational environment 100, aircraft 110 flies a mission from launch point A to destination B, navigating according to LiDAR images captured by one or more onboard LiDAR sensors. In some scenarios, operational environment 100 may be a GPS-denied or radar-jammed environment such that aircraft such as aircraft 110 is unable to navigate according to GPS or other similar means.

A computing device onboard aircraft 110 receives 3D point cloud 120 captured by an onboard LiDAR sensor. The computing device processes the image to render a 2D point cloud which is submitted to a navigational CNN. The navigational CNN identifies landmark 121 in accordance with its training and returns a latitude and longitude of the landmark based on information associated with 3D point cloud 120. The computing device determines a first present position of aircraft 110 based on the latitude and longitude information received from the navigational CNN, taking into account the position of the LiDAR sensor relative to the landmark and the time at which the image was captured, along with confidence metric determined by the CNN. The computing device also receives altitude information of aircraft 110 based on ranging information associated with 3D point cloud 120.

The computing device also receives other imaging data of a second modality, such as EO, infrared, multispectral, or other (non-LiDAR) imaging. The computing device uses a second navigational CNN to identify known landmarks in the images in the imaging data. The second navigational CNN also identifies landmark 121 and returns latitude and longitude information for landmark 121 along with a confidence metric. The computing device determines a second present position of aircraft 110 based on the latitude and longitude information received from the second navigational CNN for landmark 121, taking into account the position of the imaging sensor relative to the landmarks and the time at which the image was captured. To generate a final or composite position of the aircraft, the first and second positions of the aircraft are aggregated according to the respective confidence metrics.

When a final or composite position of the aircraft has been determined based on the imaging data, the computing device onboard aircraft 110 may execute a position check or verification of the information against data collected from various onboard sensors, such as a gyroscope, compass, IMU, and the like. If the present position as determined based on the location information returned by the navigational CNNs varies from a position determined based on the physical sensor data by more than a threshold amount, the present position determination may be discarded as erroneous. In some implementations, the output of the navigational CNNs may be calibrated against the physical sensor data to improve the accuracy.

Based on the present position of aircraft 110 determined by the navigational CNNs, a flight computer determines flight path 130 to destination B. As the onboard LiDAR sensors continue to capture LiDAR images along flight path 130 and updates flight path 130 based on positional information derived from the images.

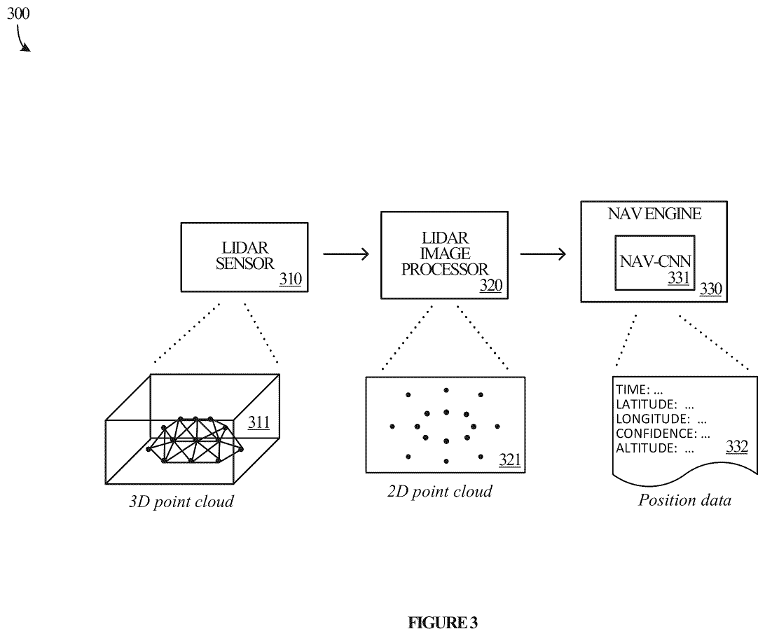

Turning now to FIG. 3, operational architecture 300 illustrates processing performed on LiDAR imaging data to determine a location of the LiDAR imaging sensor or the aircraft on which the sensor operates. In operational architecture 300. LiDAR sensor 310 captures 3D point cloud 311 of an area. 3D point cloud 311 includes information relating to the elevation of points on the ground at various locations in the imaged area.

3D point cloud 311 is processed by LiDAR image processor 320 to obtain 2D point cloud 321. To process 3D point cloud 311, LiDAR image processor 320 orthorectifies the data to obtain a downward normal perspective of the point cloud, then projects the orthorectified data to a ground plane, as illustrated in 2D point cloud 321. 2D point cloud 321 retains elevation information in the form of a relative brightness of the points of the point cloud, e.g., the brighter points will correspond to a higher elevation.

2D point cloud 321 is then fed to navigation engine 330 which hosts or executes navigation CNN 331 to process the data. Navigation CNN 330 receives an input vector corresponding to 2D point cloud 321 and processes the data to identify any landmarks in the data and ascertain the location (e.g., latitude, longitude) of the identified landmarks. Navigation engine 330 receives the location information including the location coordinates and a confidence metric relating to the location determination made by navigation CNN 331. In an implementation, navigation engine 330 generates position data 332 for transmission to a flight control system of the aircraft including the latitude, longitude, and confidence metric along with a time corresponding to when 3D point cloud 311 was captured. Position data 332 may also include altitude information derived from 3D point cloud 311 or 2D point cloud 321.

The interaction between LiDAR sensor 310, LiDAR image processor 320, navigation engine 330, and navigation CNN 331 may be conducted via various application programming interfaces (APIs) hosted by the various components of operational architecture 300. Similarly, navigation engine 330 may supply position data 332 to a flight control computer or system onboard the aircraft via an API.

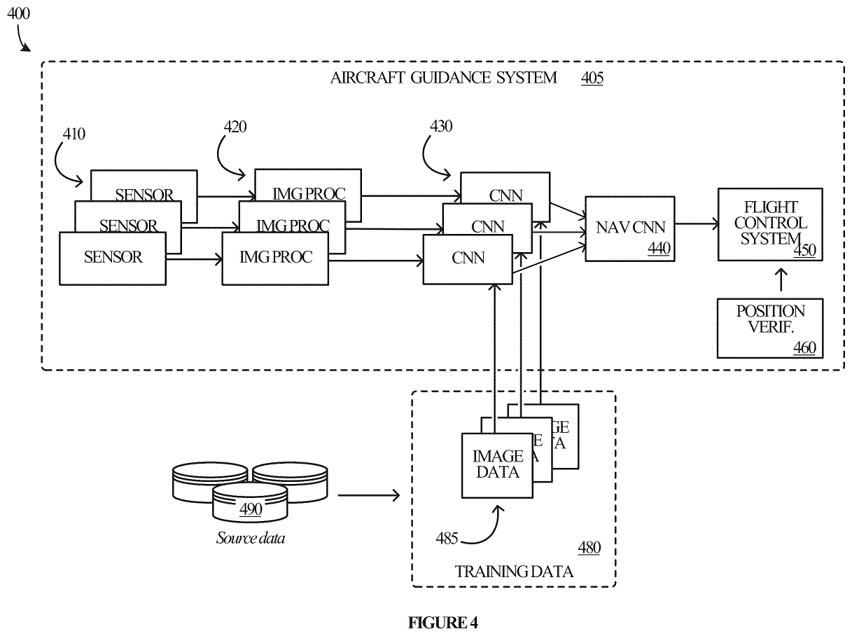

FIG. 4 illustrates operational architecture 400 for aircraft navigation based on image processing in an implementation. In operational architecture 400, an aircraft (not shown), such as an unmanned aerial vehicle, navigates by means of aircraft guidance system 405. Aircraft guidance system 405 includes sensors 410, image processors 420, CNNs 430, navigation CNN 440, flight control system 450, and position verification system 450. Operational architecture 400 also includes source data 490 and training data 480 which in turn includes image data 485 for training CNNs 430, respectively.

Sensors 410 are representative of imaging sensors of one or more modalities onboard an aircraft for capturing images of the ground including overhead perspectives, horizon perspectives, and the like. Sensors 410 can include an EO sensor for capturing visible spectrum imagery, an infrared (IR) sensor for thermal imaging, synthetic aperture radar (SAR) for high-resolution radar imaging, and a LiDAR sensor for precise distance measurements and three-dimensional mapping. Additional modalities of sensors 410 can include a hyperspectral sensor for capturing data across a wide range of electromagnetic wavelengths, a multispectral sensor for targeted wavelength imaging, an ultraviolet (UV) sensor for specialized detection tasks, a passive microwave sensor for atmospheric and surface observations, and an acoustic sensor for capturing sound-based imaging data. Sensors 410 can include different combinations of the above-described modalities, e.g., an EO sensor, an IR sensor, and an acoustic sensor. Combining sensors of different modalities enables comprehensive data collection across multiple spectral and operational domains, allowing for enhanced situational awareness and ground analysis.

Image processors 420 are representative of one or more functionalities for preparing image data from sensors 410, respectively, for processing by modality-specific CNNs 430. In various implementations, the image processing operations of image processors 420 prepare raw data from sensors 410 for input to CNNs 430, ensuring that key spatial, spectral, and geometric information necessary for landmark identification is retained. Because different imaging modalities-such as optical, infrared, multispectral, SAR, etc.—each exhibit unique strengths and limitations, image processors 420 apply modality-specific preprocessing to optimize landmark visibility and consistency including modality-specific calibration, normalization, distortion correction, or noise reduction operations. For example, SAR data received from a SAR sensor of sensors 410 may be dechirped and motion compensated (i.e., correct for motion-induced distortions) by a SAR data processor of image processors 420. Similarly, LiDAR point cloud data may be transformed into two-dimensional representations or voxel grids for compatibility with the respective CNN of CNNs 430. Other examples of preprocessing by image processors 420 include radiometric correction to normalize sensor responses in the imaging data, denoising to improve contrast in thermal and infrared imaging, and spectral calibration to preserved diagnostic features. By tailoring the preprocessing steps performed by image processors 420 to the characteristics of each modality, the preprocessed imaging data maintain their fidelity and enhance the ability of CNNs 430 to extract and classify relevant features.

CNNs 430 are representative of specialized (i.e., modality-specific) convolutional neural network models for processing image data received from sensors 410, respectively. CNNs 430 can include deep learning models each of which is trained or optimized for a particular modality (e.g., EO, LiDAR, thermal) and which are designed to extract hierarchical features from the image data for tasks such as landmark detection and classification. CNNs 430 receive feature vectors from image processors 420 and detect or identify landmarks (e.g., building, geographic features) in accordance with their training. CNNs 430 generate output including encodings of any landmarks identified in the imaging data. In an implementation, the encodings generated by each of CNNs 430 include parameters which describe distinctive features detected in the imaging data. The parameters may include spatial structure, texture patterns, edge orientations, spectral signatures, shape descriptors, intensity gradients, depth cues, and the like. The encodings are returned as an input or feature vector (i.e., a data structure comprising data values organized in an array, the values of which are accessible by an index corresponding to each position in the array) for submission to CNN 440. The encodings generated by CNNs 430 are submitted to navigation CNN 440 for location identification.

CNNs 430 can include architectures tailored to specific imaging modalities, such as ResNet, EfficientNet, or U-Net for EO and IR images, and specialized architectures for handling three-dimensional data, such as PointNet for LiDAR point clouds. For SAR data, CNNs 430 may incorporate preprocessing layers to handle complex-valued inputs and exploit the unique textural features of radar images. For hyperspectral and multispectral data, the CNNs may include spectral attention mechanisms or 3D convolutional layers to capture correlations across spectral dimensions. CNNs 430 may also employ transfer learning, where pretrained models are fine-tuned for domain-specific applications, or utilize multimodal fusion techniques to combine information from multiple sensor inputs. CNNs 430 may undergo broad-based training for landmark identification over a number of different types of terrain (e.g., urban, rural, agricultural, desert, mountainous). Upon completion of broad-based training for landmark identification, CNNs 430 may be fine-tuned with image data 485 of a particular area or region of interest.

Navigation CNN 440 is representative of a convolutional neural network model trained to determine location coordinates based on features identified by CNNs 430 in image data from sensors 410. The output of CNNs 430 may include actionable insights such as target identification, terrain classification, or change detection, depending on the operational requirements. At inference (e.g., during a mission), to determine position information, CNNs 430 may be trained on image data 485 to determine a position or location of the sensor (i.e., the aircraft carrying the sensor) based on identifying landmarks in the images captured by sensors 410.

Image data 485 of training data 480 are representative of sets of images or image data of different modalities which include distinctive landmarks, geographical features, or other information by which a location of an aircraft can be determined. Image data 485 can include sets of images of modalities such as EO, LiDAR, infrared, SAR, and the like. In various implementations, to train CNNs 430, the sets of image data 485 include images of common terrain, such as the terrain over which a mission is to be flown. The sets of image data 485 may be resampled so the images are commensurate in size and/or scale with the imaging data generated by the onboard sensors 410. In an implementation, image data 485 is derived from source data 490 (e.g., publicly available imaging data) which includes image data corresponding to a modality of a sensor of sensors 410.

In various implementations, CNNs 430 are trained, respectively, on image data 485 of a corresponding modality. Training data 480 includes image data 485 which include images of identifiable landmarks or terrain; in various implementations, to train CNNs 430, each of image data 485 are sets of images captured of the same terrain, e.g., the terrain to be traversed by the aircraft on a given mission. The images of image data 485 may be resampled so the images are on the same order of or commensurate in size and/or scale with the imaging data which would be generated by the respective sensors of sensors 410. During training, image data 485 are ingested by the corresponding models of CNNs 430. For example, EO image data of image data 485 is ingested by an EO CNN model of CNNs 430; infrared spectrum image data of image data 485 is ingested by an infrared spectrum CNN of CNNs 430; and so on. Based on their training, CNNs 430 output encodings for the detected features or landmarks of image data 485. Some images in training data 480 may contain multiple features or landmarks, and CNNs 430 are trained to return location information for every detected feature or landmark in an image.

In an exemplary operation of operational architecture 400, each of sensors 410 captures images of the terrain traversed by the aircraft, wherein the images include data captured according to the respective sensor modality. For example, a first sensor of sensors 410 captures images captured which include a representation of the imaged terrain according to the modality of the first sensor (e.g., EO, IR, LiDAR) and transmits the images to a first image processor (corresponding to the modality of the given sensor) of image processors 420 for preprocessing. Executing in parallel with the first sensor, a second sensor (of a different modality than the first sensor) captures imaging data of the terrain over which the aircraft is flying, the images are transmitted for preprocessing to a second one of image processors 420 of a corresponding modality. In various implementations, others of sensors 410 may similarly capture imaging data of the traversed terrain according to modalities different from those of the first and second sensors and preprocessed by others of image processors 420 according to the respective modalities.

The images received from the first and second sensors of sensors 410 are preprocessed by corresponding ones of image processors 420 to render the image data in a format (e.g., as a feature vector) suitable for input to ones of CNNs 430 of corresponding modality. The preprocessed images are fed to CNNs 430 each of which outputs an encoding of features identified in the respective image data. For example, first and second CNNs of CNNs 430 receive the preprocessed image data from the corresponding ones of image processors 420 and process the data to detect and encode of features (e.g., distinctive landmarks) in the data. Each of the CNNs 430 may also return a confidence metric relating to their feature detections.

Next, the encodings generated by CNNs 430 are received as input by navigation CNN 440 which identifies a position or location (e.g., GPS coordinates) of the aircraft based on correlating any encoded features in the input vectors to known landmarks. The correlation generated by navigation CNN 440 may be determined in view of any confidence metrics generated in association with the detected features; navigation CNN 440 may also determine an aggregate confidence metric associated with its location identification. In some scenarios, sensors 410 include a LiDAR sensor, and LiDAR data can be used to determine the altitude of the aircraft.

Executing in parallel with the first and second sensors, other sensors of sensors 410 may produce imaging data which are processed and fed to corresponding image processors of image processors 420, thence to corresponding CNNs of CNNs 430, thence to navigation CNN 440 to return position information and an associated indication of confidence. In this way, imaging data of multiple modalities can be used to generate location information for navigating the aircraft; because the various modalities will have different operational characteristics which depend on the conditions (e.g., weather, time of day), as a combination, the use of multiple modalities improves the overall probability or confidence that aircraft guidance system 405 will continually receive reliable data for navigation.

The location data received from navigation CNN 440 is supplied to flight control system 450 which verifies the identified location against other locational information (e.g., gyroscopic data, compass data, IMU data, accelerometer data). Based on determining the location of the aircraft, aircraft guidance system 405 generates flight commands for the propulsion system (not shown) of the aircraft to navigate the aircraft according to the flight parameters specified for the mission.

When flight control system 450 receives an indication of the location of the aircraft from navigation CNN 440, the location is checked or verified by position verification system 460 against location data from other sensors (e.g., IMUs, accelerometers) onboard the aircraft. If the location data falls within an acceptable threshold of accuracy, the verified location data or an indication of verification is returned to flight control system 450. Based on the verified location information, flight control system 450 determines a trajectory to the destination and generates flight control commands for the propulsion, control surfaces, and other electromechanical systems of the aircraft.

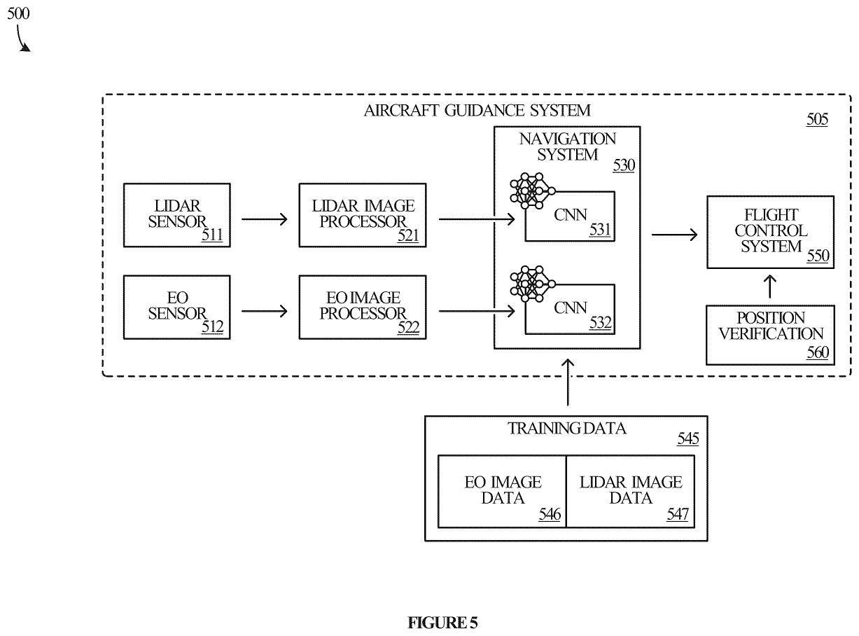

FIG. 5 illustrates operational architecture 500 for aircraft navigation based on LiDAR image processing in an implementation. In operational architecture 500, an aircraft (not shown), such as an unmanned aerial vehicle, navigates by means of aircraft guidance system 505. Aircraft guidance system 505 includes LiDAR sensor 511, EO sensor 512, LiDAR image processor 521, EO image processor 522, navigation system 530 including LiDAR CNN 531, EO CNN 532, flight control system 550, and position verification system 560.

In an implementation, LiDAR CNN 531 and EO CNN 532 are trained on training data 545 which includes EO image data 546 and LiDAR image data 547. Training data 545 includes image data including identifiable landmarks on images of terrain. In various implementations, to train LiDAR CNN 531 and EO CNN 532, EO image data 546 is paired with LiDAR image data 547 of the same terrain. The paired images of training data 545 may be resampled so the images are commensurate in size and/or scale with imaging data generated by the onboard LiDAR and EO sensors. LiDAR image data 547 is ingested by LiDAR CNN 531, while EO image data 546 is ingested as by EO CNN 532. Based on their training, LiDAR CNN 531 and EO CNN 532 output position data for the identified landmarks (e.g., latitude and longitude coordinates). Some images in training data 545 may contain multiple landmarks; each of LiDAR CNN 531 and EO CNN 532 is trained to return location information for each identified landmark in an image. Subsequent to completion of broad-based training for landmark identification, LiDAR CNN 531 and EO CNN 532 may be fine-tuned with training datasets of a particular area or region of interest.

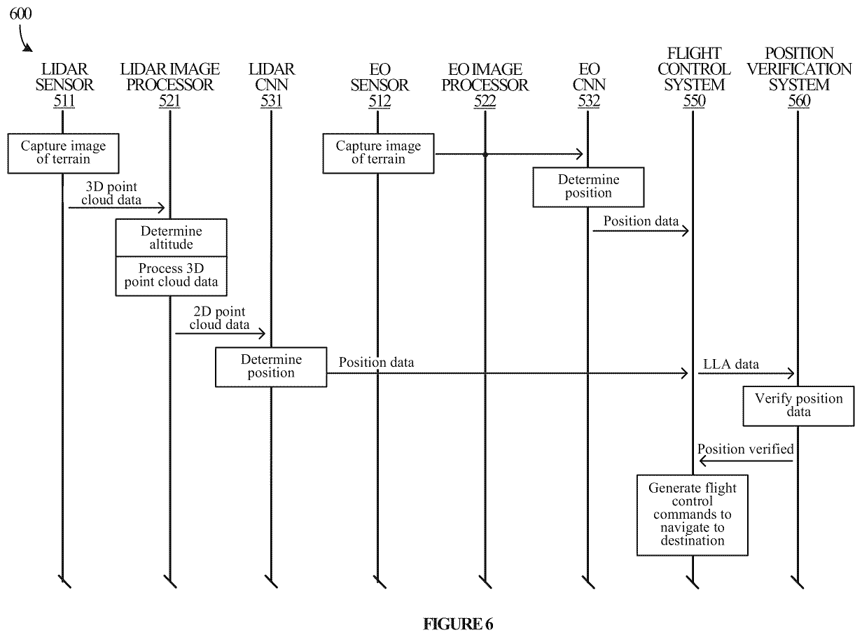

FIG. 6 illustrates workflow 600 for aircraft navigation based on LiDAR image processing in an implementation, employing elements of operational architecture 500 in an implementation.

In workflow 600, LiDAR sensor 511 captures an image of terrain over which the aircraft is flying. The images captured by LiDAR sensor 511 include 3D point cloud representations of the imaged terrain. For a given image of the captured images, LiDAR sensor 511 transmits the 3D point cloud data of the image to LiDAR image processor 521 for processing.

Upon receiving the 3D point cloud data, LiDAR image processor 521 processes the data to produce a 2D point cloud of data from the 3D point cloud data. To produce the 2D point cloud data, LiDAR image processor 521 may geo-rectify or orthorectify the data to remove distortions from data, then project the point cloud to a ground plane. LiDAR image processor 521 then transmits the 2D point cloud data to LiDAR CNN 531. LiDAR image processor 521 also determines the altitude of the aircraft based on ranging information embodied in the image data from LiDAR sensor 511.

Executing in parallel with their LiDAR counterparts, the EO imaging components similarly receive and process EO imaging data of the same terrain. EO sensor 512 captures an image of the terrain which is processed by EO image processor 522 by orthorectifying the image data and other types of processing to prepare the image data for ingestion by EO CNN 532.

LiDAR CNN 531 receives the 2D point cloud data from LiDAR image processor 521 and processes the data according to its training to produce position data based on one or more landmarks identified in the data. The position data includes latitude and longitude coordinates determined based on the latitude and longitude of each of the identified landmarks. Similarly, EO CNN 532 ingests the processed EO image data from EO image processor 522 returns position data based on landmark(s) identified in the data. Each of the two CNNs of navigation system 530 also returns a confidence metric relating to their position determinations.

Navigation system 530, including LiDAR CNN 531 and EO CNN 532, computes an aggregate position of the aircraft based on the position information received from the two CNNs. To compute an aggregate position, navigation system 530 computes a weighted average of the respective latitude and longitude information, where the weighting is based on the confidence metrics for the data. Navigation system 530 may also correct the position data for the angle of the sensor, the aircraft velocity, and/or other factors which may impact the accuracy of the determinations. Navigation system 530 supplies the aggregate position information including the aggregate latitude and longitude coordinates and an altitude determined from the LiDAR information to flight control system 550.

When flight control system 550 receives the position information, the information is checked or verified by position verification system 560 against location information from sensors (IMUs, gyroscopes, accelerometers, etc.) onboard the aircraft. If the position data falls within an acceptable threshold of accuracy, the verified position data or an indication of verification is returned to flight control system 550. Based on the position information received from navigation system 530, flight control system 550 determines a trajectory to the destination and generates flight control commands for the propulsion, control surfaces, and other electromechanical systems of the aircraft.

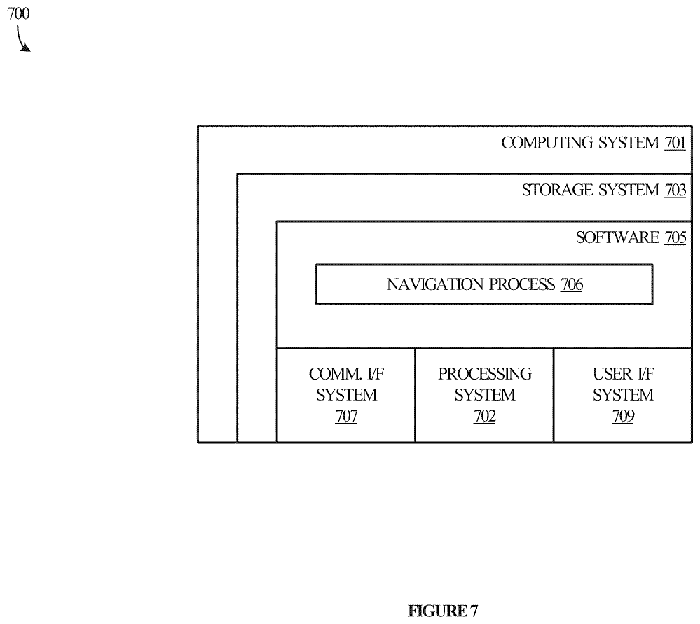

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements navigation process 706, which is (are) representative of the navigation processes discussed with respect to the preceding Figures, such as process 200 and workflow 600. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including navigation process 706) may be implemented in program instructions and among other functions may, when executed by processing system 702, direct processing system 702 to operate as described with respect to the various operational scenarios, sequences, and processes illustrated herein. For example, software 705 may include program instructions for implementing a navigation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support aircraft navigation based on LiDAR image processing in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

### EXAMPLES

The following illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).

Example 1 is a computing apparatus comprising: one or more computer readable storage media; one or more processors operatively coupled with the one or more computer readable storage media; and program instructions stored on the one or more computer readable storage media that, when executed by the one or more processors, direct the computing apparatus to at least: receive LiDAR imaging data of an area of terrain from a LiDAR sensor onboard an aircraft; receive other imaging data of the area of terrain from a second imaging sensor onboard the aircraft; determine, by a first neural network, a first landmark location based on an identification of the first landmark in the LiDAR imaging data; determine, by a second neural network, a second landmark location based on an identification of a second landmark in the other imaging data; and compute a location of the aircraft in three-dimensional (3D) space based on the first landmark location and second landmark location.

Example 2 is the computing apparatus of any previous or subsequent example, wherein the other imaging data comprises electro-optical imaging data and wherein the second imaging sensor comprises an electro-optical sensor.

Example 3 is the computing apparatus of any previous or subsequent example, wherein the LiDAR imaging data comprises 3D point cloud data of the area of terrain and wherein the program instructions further direct the computing apparatus to orthorectify the 3D point cloud data and to project the 3D point cloud data to a ground plane to produce two-dimensional (2D) point cloud data of the area of terrain for ingestion by the first neural network.

Example 4 is the computing apparatus of any previous or subsequent example, wherein the program instructions further direct the computing apparatus to determine an altitude of the aircraft based on the 3D point cloud data.

Example 5 is the computing apparatus of any previous or subsequent example, wherein the program instructions further direct the computing apparatus to verify the location of the aircraft against onboard sensor data.

Example 6 is the computing apparatus of any previous or subsequent example, wherein the onboard sensor data includes one or more of: gyroscopic data, compass data, inertial measurement unit data, accelerometer data, and altimeter data.

Example 7 is the computing apparatus of any previous or subsequent example, wherein the first and second neural networks are trained to return landmark locations based on identifying landmarks in imaging data and wherein the first and second neural networks are trained on datasets comprising pairs of images of terrain including known landmarks.

Example 8 is the computing apparatus of any previous or subsequent example, wherein the program instructions further direct the computing apparatus to determine a confidence metric for each of the first landmark location and the second landmark location.

Example 9 is a method of operating an aircraft comprising: receiving LiDAR imaging data of an area of terrain from a LiDAR sensor onboard the aircraft; receiving other imaging data of the area of terrain from a second imaging sensor onboard the aircraft; determining, by a first neural network, a first landmark location based on an identification of the first landmark in the LiDAR imaging data; determining, by a second neural network, a second landmark location based on an identification of a second landmark in the other imaging data; and computing a location of the aircraft in three-dimensional (3D) space based on the first landmark location and second landmark location.

Example 10 is the method of any previous or subsequent example, wherein the other imaging data comprises electro-optical imaging data and wherein the second imaging sensor comprises an electro-optical sensor.

Example 11 is the method of any previous or subsequent example, wherein the LiDAR imaging data comprises 3D point cloud data of the area of terrain and wherein the method further comprises orthorectifying the 3D point cloud data and projecting the 3D point cloud data to a ground plane to produce two-dimensional (2D) point cloud data of the area of terrain for ingestion by the first neural network.

Example 12 is the method of any previous or subsequent example, further comprising determining an altitude of the aircraft based on the 3D point cloud data.

Example 13 is the method of any previous or subsequent example, further comprising verifying the location of the aircraft against onboard sensor data.

Example 14 is the method of any previous or subsequent example, wherein the first and second neural networks are trained to return landmark locations based on identifying landmarks in imaging data and wherein the first and second neural networks are trained on datasets comprising pairs of images of terrain including known landmarks.

Example 15 is the method of any previous or subsequent example, further comprising computing a confidence metric for each of the first landmark location and second landmark location.

Example 16 is one or more computer readable storage media having program instructions stored thereon that, when executed by one or more processors, direct a computing device to at least: receive LiDAR imaging data of an area of terrain from a LiDAR sensor onboard an aircraft; receive other imaging data of the area of terrain from a second imaging sensor onboard the aircraft; determine, by a first neural network, a first landmark location based on an identification of the first landmark in the LiDAR imaging data; determine, by a second neural network, a second landmark location based on an identification of a second landmark in the other imaging data; and compute a location of the aircraft in three-dimensional (3D) space based on the first landmark location and second landmark location.

Example 17 is the one or more computer readable storage media of any previous or subsequent example, wherein the other imaging data comprises electro-optical imaging data and wherein the second imaging sensor comprises an electro-optical sensor.

Example 18 is the one or more computer readable storage media of any previous or subsequent example, wherein the LiDAR imaging data comprises 3D point cloud data of the area of terrain and wherein the program instructions further direct the computing device to orthorectify the 3D point cloud data and to project the 3D point cloud data to a ground plane to produce two-dimensional (2D) point cloud data of the area of terrain for ingestion by the first neural network.

Example 19 is the one or more computer readable storage media of any previous or subsequent example, wherein the program instructions further direct the computing device to determine an altitude of the aircraft based on the 3D point cloud data.

Example 20 is the one or more computer readable storage media of any previous or subsequent example, wherein the first and second neural networks are trained to return landmark locations based on identifying landmarks in imaging data and wherein the first and second neural networks are trained on datasets comprising pairs of images of terrain including known landmarks.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive first imaging data of an area of terrain from a first sensor onboard an aircraft, wherein the first imaging data comprises LiDAR imaging data and wherein the first sensor comprises a LiDAR sensor;
receive second imaging data of the area of terrain from a second imaging sensor onboard the aircraft;
determine, by a first neural network, a first landmark location based on an identification of the first landmark in the first imaging data;
determine, by a second neural network, a second landmark location based on an identification of a second landmark in the second imaging data; and
determine a location of the aircraft in three-dimensional (3D) space based on the first landmark location and second landmark location.

2. The computing apparatus of claim 1, wherein the second imaging data comprises electro-optical imaging data and wherein the second imaging sensor comprises an electro-optical sensor.

3. The computing apparatus of claim 1, wherein the LiDAR imaging data comprises 3D point cloud data of the area of terrain and wherein the program instructions further direct the computing apparatus to orthorectify the 3D point cloud data and to project the 3D point cloud data to a ground plane to produce two-dimensional (2D) point cloud data of the area of terrain for ingestion by the first neural network.

4. The computing apparatus of claim 3, wherein the program instructions further direct the computing apparatus to determine an altitude of the aircraft based on the 3D point cloud data.

5. The computing apparatus of claim 1, wherein the program instructions further direct the computing apparatus to verify the location of the aircraft against onboard sensor data.

6. The computing apparatus of claim 5, wherein the onboard sensor data includes one or more of: gyroscopic data, compass data, inertial measurement unit data, accelerometer data, and altimeter data.

7. The computing apparatus of claim 1, wherein the first and second neural networks are trained to return landmark locations based on identifying landmarks in imaging data and wherein the first and second neural networks are trained on datasets comprising pairs of images of terrain including known landmarks.

8. The computing apparatus of claim 1, wherein the program instructions further direct the computing apparatus to determine a confidence metric for each of the first landmark location and the second landmark location.

9. A method of operating an aircraft comprising:
receiving first imaging data of an area of terrain from a first sensor onboard the aircraft, wherein the first imaging data comprises LiDAR imaging data and wherein the first sensor comprises a LiDAR sensor;
receiving second imaging data of the area of terrain from a second imaging sensor onboard the aircraft;
determining, by a first neural network, a first landmark location based on an identification of the first landmark in the first imaging data;
determining, by a second neural network, a second landmark location based on an identification of a second landmark in the second imaging data; and
determining a location of the aircraft in three-dimensional (3D) space based on the first landmark location and the second landmark location.

10. The method of claim 9, wherein the second imaging data comprises electro-optical imaging data and wherein the second imaging sensor comprises an electro-optical sensor.

11. The method of claim 9, wherein the LiDAR imaging data comprises 3D point cloud data of the area of terrain and wherein the method further comprises orthorectifying the 3D point cloud data and projecting the 3D point cloud data to a ground plane to produce two-dimensional (2D) point cloud data of the area of terrain for ingestion by the first neural network.

12. The method of claim 11, further comprising determining an altitude of the aircraft based on the 3D point cloud data.

13. The method of claim 9, further comprising:
receiving third imaging data of the area of terrain from a third sensor onboard the aircraft, wherein the third sensor comprises a modality different from a modality of the first sensor and different from a modality of the second sensor; and
determine, by a third neural network, a third landmark location based on an identification of the third landmark in the third imaging data.

14. The method of claim 13, wherein determining the location of the aircraft in 3D space is further based on the third landmark location.

15. The method of claim 9, further comprising computing a confidence metric for each of the first landmark location and the second landmark location.

16. One or more computer readable storage media having program instructions stored thereon that, when executed by one or more processors, direct a computing device to at least:
receive LiDAR imaging data of an area of terrain from a LiDAR sensor onboard an aircraft;
receive second imaging data of the area of terrain from a second imaging sensor onboard the aircraft;
determine, by a first neural network, a first landmark location based on an identification of the first landmark in the LiDAR imaging data;
determine, by a second neural network, a second landmark location based on an identification of a second landmark in the second imaging data; and
determine a location of the aircraft in three-dimensional (3D) space based on the first landmark location and second landmark location.

17. The one or more computer readable storage media of claim 16, wherein the second imaging data comprises electro-optical imaging data and wherein the second imaging sensor comprises an electro-optical sensor.

18. The one or more computer readable storage media of claim 16, wherein the LiDAR imaging data comprises 3D point cloud data of the area of terrain and wherein the program instructions further direct the computing device to orthorectify the 3D point cloud data and to project the 3D point cloud data to a ground plane to produce two-dimensional (2D) point cloud data of the area of terrain for ingestion by the first neural network.

19. The one or more computer readable storage media of claim 18, wherein the program instructions further direct the computing device to determine an altitude of the aircraft based on the 3D point cloud data.

20. The one or more computer readable storage media of claim 16, wherein the first and second neural networks are trained to return landmark locations based on identifying landmarks in imaging data and wherein the first and second neural networks are trained on datasets comprising pairs of images of terrain including known landmarks.
